(19) United States
(12) Patent Application Publication
(10) Pub. No.: US 2011/0050020 A1
(43) Pub. Date: Mar. 3, 2011

(54) ELECTRONIC MACHINES WITH COMPOSITE POLES

(75) Inventors: Zvonko Lazic, Auckland (NZ); Gordon Harry Evans, Auckland (NZ)

(73) Assignee: WELLINGTON DRIVE TECHNOLOGIES LIMITED, North Harbour, Auckland (NZ)

(21) Appl. No.: 12/442,548

(22) PCT Filed: Sep. 18, 2007
(86) PCT No.: PCT/NZ2007/000271

§ 371 Date: Nov. 30, 2009

(30) Foreign Application Priority Data
Sep. 4, 2007 (NZ) 550078

(51) Int. Cl. H02K 21/12; H02K 15/00

(52) U.S. Cl. 310/156.01; 29/596

(57) ABSTRACT

An electric motor or generator consists of a stator carrying pole pieces and their coacting coils, the stator being surrounded on one side by the field creating permanent magnets adjacent one face of the poles and on the other by a flux return path element positioned adjacent the other face of the poles. The stator coils are preferably bobbin mounted.

### TECHNICAL FIELD

The invention generally relates to electrodynamic machines in which the poles are separated from the remainder of the magnetic structure.

More particularly the invention relates to an electrodynamic machine in which the pole windings and the pole face which is contiguous the relatively moving part of the machine are created separated from the magnetic material which acts as the return path for the magnetic flux.

### BACKGROUND ART

Electrodynamic machines such as motors and generators typically consist of a stator and a rotor, one of which carries pole pieces associated with coils which, in the case of a motor, are energised by a current while the other either has permanent magnets or electromagnets to create a flux against which the coils act. Normally there are many pole pieces with their associated coils and the number of connections to these encourage the placement of this part of the machine as the stator, while the magnetic field creation portion is the rotor.

The stator requires a flux path to return the magnetic flux from the pole pieces via the magnetic flux creation path to the rear of the pole pieces. This is normally done with a path through an adjacent pole or poles or through the support structure to the magnetic structure supporting the pole pieces at the rear. Such a magnetic structure is complex to assemble and expensive to manufacture as the coils for the pole pieces normally need to be shaped to fit the poles and the backing magnetic structure. U.S. Pat. No. 7,067,944 shows a typical example of such a construction in which the stator structure is injection moulded to the baseplate.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in an electrodynamic machine having a unitary annular first structure comprising multiple magnetically isolated pale pieces arranged around an axis, each pole piece having a first face and a second face and at least one pole coil located on each pole piece between the first and second faces, a second structure rotatably mounted on the first structure axis and comprising a magnetic flux creation device for each pole piece wherein there exists a magnetic flux conducting path via the second structure from a first face of each pole piece via at least one magnetic flux creation device to the second face of the pole piece.

Preferably the machine is an axial flux machine and the pole pieces are radially arranged around the axis.

Preferably the machine is a radial flux machine and the pole pieces are axially arranged around the axis.

Preferably the pole pieces are trapped between a common base plate and a common top plate.

Preferably each pole piece carries a groove at each end to facilitate the trapping.

Preferably the groove is arcuate and coacts with a corresponding projection on the base plate or top plate.

Preferably the machine is a drum machine.

Preferably each pole coil is wound on a bobbin.

Preferably the bobbins, coils and pole pieces are unitised as a first structure by embedding in a substrate.

Preferably the substrate is created by injection moulding.

Preferably the second structure has a band of magnetic structure located adjacent the outer faces of the poles.

Preferably the band forms part of the second structure.

Preferably the band is inside the first structure and the permanent magnets are outside the first structure.

Preferably the band and magnets are mounted to the same magnetic material

Preferably the first structure is stationary and the second structure rotates.

Preferably the magnetic flux creation devices are permanent magnets.

Alternatively the invention relates to a method of constructing a radial flux electrodynamic machine having a unitary annular stator structure comprising providing a plurality of pole pieces, mounting pole coils to the pole pieces and assembling the pole pieces and coils to form an annular stator with each pole axis radially oriented, embedding the pole pieces and coils in a substrate to thereby unitise the stator, assembling magnetic field creating elements and a pole piece backing element in a rotor with at least one magnetic flux path between the magnetic field creating elements and the pole piece backing element and assembling the stator and rotor.

Preferably the pole coils are wound on bobbins and the bobbins are placed on pole pieces.

Preferably the pole pieces and bobbins are retained in place on a base plate prior to embedding the pole pieces and coils.

Alternatively the invention relates to a method of constructing an annular flux electrodynamic machine having a unitary annular stator structure comprising providing a plurality of pole pieces, mounting pole coils to the pole pieces and assembling the pole pieces and coils to form an annular stator with each pole axis axially oriented, embedding the pole pieces and coils in a substrate to thereby unitise the stator, assembling magnetic field creating elements and a pole piece backing element in a rotor with at least one magnetic flux path between the magnetic field creating elements and the pole piece backing element and assembling the stator and rotor.

These and other features of as well as advantages which characterise the present invention will be apparent upon reading of the following detailed description and review of the associated drawings.

### BRIEF DESCRIPTION OF THE DRAWINGS

FIG. 1 is a sectioned perspective view of a motor according to the invention.

FIG. 2 is a cross section of the rotor of FIG. 1.

FIG. 3 is a cross section of the stator of FIG. 1

FIG. 4 is a cross section on line 4-4 of the stator of FIG. 3

FIG. 5 is an exploded view of the stator of FIG. 1

FIG. 6 is an exploded view of a winding and pole piece of FIG. 5.

FIG. 7 is a sectioned view of a radial flux motor according to the invention.

FIG. 8 is a sectioned perspective view of an axial flux motor according to the invention.

### DESCRIPTION OF THE INVENTION

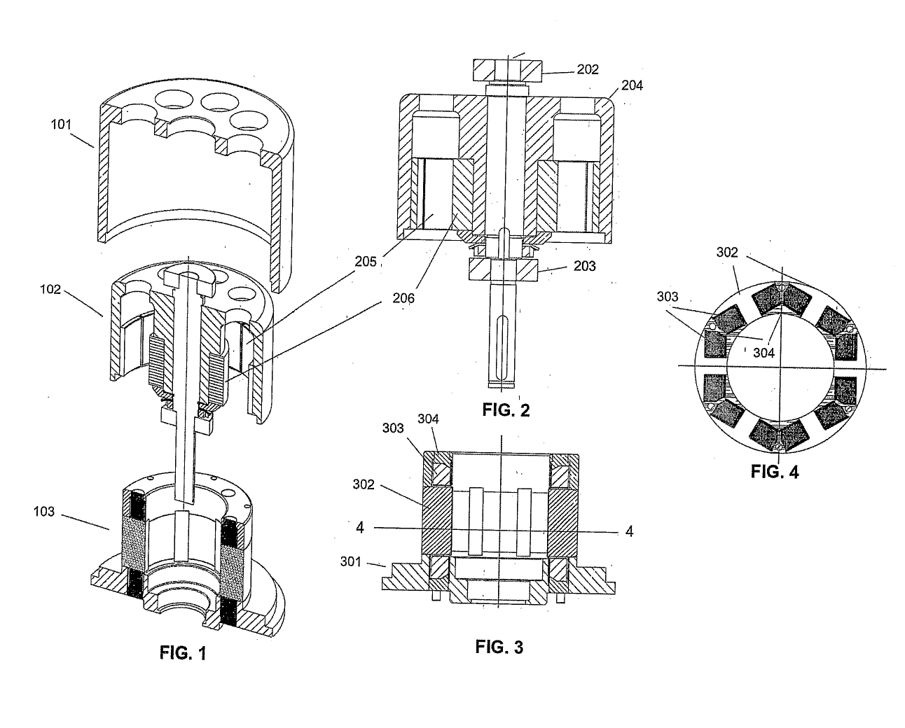

Referring now to FIG. 1 a motor according to one exemplification of the invention is shown in cross section and consists of an outer casing 101, a rotor 102 and a stator 102.

As best seen in FIG. 2 the rotor 102 consists of an axle 201 journalled in bearings 202, 203. A cup 204 of magnetic material such as iron or soft steel carries magnets 205 and a back iron 206. The magnets face alternately north and south pole inwards. Magnetic flux is conducted through the rotor body 204 from the magnets to the back iron 206, which may be of laminated form.

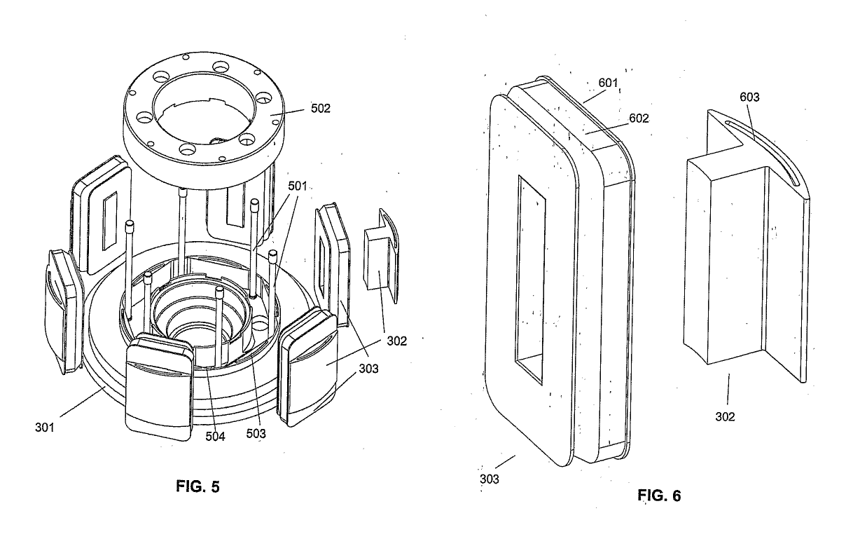

Co-operating with rotor 102 is stator 103 shown in FIG. 3, with a cross section in FIG. 4 and detail in FIG. 5. A base plate 301 which locates on bearing 203 receives an assemblage of magnetically isolated pole pieces such as 302 carrying coils wound on bobbins 303. This assemblage is encapsulated in a suitable potting material 304 and is fixed to the base plate typically by through bolts.

A suitable potting material may be any non-conductive material with a modulus of expansion approximating that of the bobbins and pole pieces and adhering to them, and a strength and modulus of elasticity sufficient to maintain the part placement while reducing the likelihood of brittle fracture. Most electronic component epoxy or polyurethane potting compounds are suitable and thermoplastics may also be used in low temperature applications.

The pole pieces may be assemblies of laminated steel but preferably they are moulded pieces of magnetic powder and may be fired ferritic components or pressure moulded adhesive magnetic powder of the required qualities. Each pole piece is isolated magnetically from the other pole pieces, that is, there are no magnetic members bridging between the pole pieces within the stator. This reduces the amount of magnetic material required to form the stator, reducing the cost and weight of the stator assembly.

FIG. 5 shows base 301 with a recess to receive the pole pieces 302 when fitted with windings 303. As best seen in FIG. 6 the windings consist of a bobbin 601 which receives a winding 602. The winding and bobbin may be tapered at one side to allow the windings to be as close together as possible. A groove 603 at each end of a pole piece co-acts with a projection 503 on the base and a similar projection on end cap 502 to prevent movement of the pole pieces. Cap 502 is retained by bolts 501. The assemblage of pole pieces and windings may be potted into an integral assembly prior to assembling it to the base, or it may be potted once assembled to the base, thus rendering the stator an integral assembly.

In operation rotor 102 is journalled in casing 101 and the base of stator 103, and the case and base secured together so that the permanent magnets 205 and back iron 206 rotate around the stator. The clearance between back iron 206 and the stator inner surface is preferably as small as is consistent with tolerances, load and temperature. Because the backiron moves in synchronism with the magnetic poles there is a reduction in eddy currents in the backiron, providing an increase in efficiency.

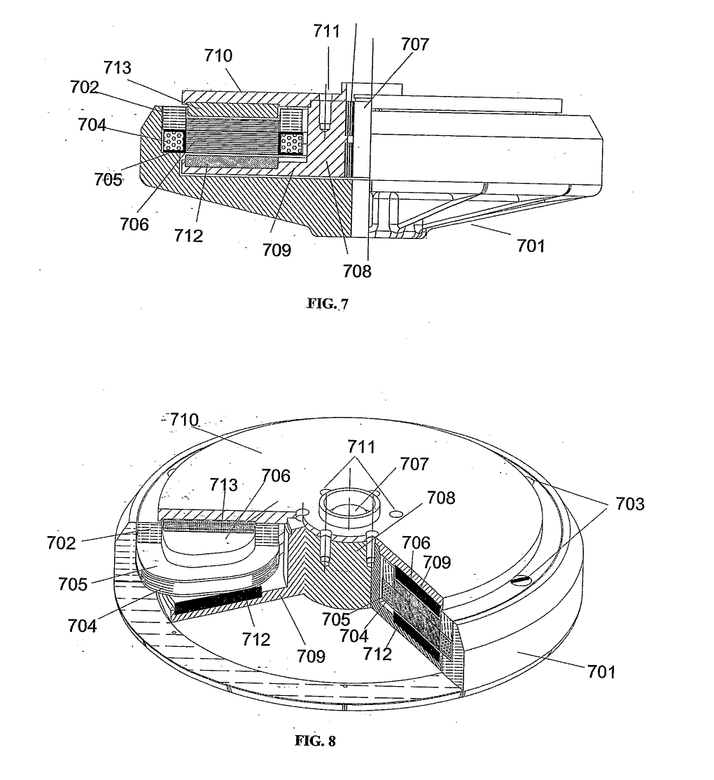

FIG. 7 and FIG. 8 show respectively a sectioned side view and a sectioned perspective view of an axial flux version of a motor in which a motor casing 701 has a stator 702 secured to it by screws at 703. The stator 702 is an injection moulded assembly having embedded within it coils 704 which may be wound within bobbins 705 and which are mounted around pole pieces 706. The coils 704, which may be sectorial in plan, may be wound on bobbins for ease of manufacture, although coils wound directly upon the pole pieces 706 and injection moulded into a whole are an alternative construction.

Case 701 may be moulded as either a zinc based die casting or as injection moulded fibre reinforced plastic, since no magnetic material is required in the case. A central axle 707 journals, on bearings 714, a rotor structure 708, this including two planar discs 709 and 710. Disc 710 is attached to the remainder of the rotor 708 by screw in holes 711. Affixes to disc 709 is a back iron continuous annular strip 712. Similarly affixed to the upper disc 710 is a magnet ring 713, with a magnet formed for each pole 706. Alternatively the magnets may be sectorial magnets secured to a back iron such as that at 712. The back iron 712 and magnet ring 713 act to provide a flux return path through the pole pieces, and hence the rotor may also be of injection moulded fibre reinforced plastics, albeit the top disc 710 must be secured to the bottom disc 709 after assembly.

The bobbins are intentionally simple both to wind and place, providing advantages in the construction of the motor while simultaneously achieving an efficiency comparable with current deformed winding technology. In addition the construction provides a very compact motor form containing only components which are simple to manufacture.

While permanent magnet pole flux generators are described the technology is equally applicable to electromagnetic flux generators.

The machine in the drum form may be constructed with either the back iron inside the coils or the back iron outside the coils

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the machine may vary dependent on the particular application for which it is used without variation in the spirit and scope of the present invention.

In addition, although the preferred embodiments described herein are directed to a six pole permanent magnet motor, it will be appreciated by those skilled in the art that the teachings of the present invention can be applied to other systems such as generators or motors with a differing number of poles, without departing from the scope and spirit of the present invention.

### INDUSTRIAL APPLICABILITY

The invention is used in the construction of motors and generators which are employed it electrical industry. The present invention is therefore industrially applicable.

1. An electrodynamic machine having a unitary annular first structure comprising multiple magnetically isolated pole pieces arranged around an axis, each pole piece having a first face and a second face and at least one pole coil locate on each pole piece between the first and second faces, a second structure rotatably mounted on the first structure axis and comprising a magnetic flux creation device for each pole piece wherein there exists a magnetic flux conducting path via the second structure from a first face of each pole piece via at least one magnetic flux creation device to the second face of the pole piece.

2. An electrodynamic machine as claimed in claim 1 wherein the machine is an axial flux machine and the pole pieces are radially arranged around the axis.

3. An electrodynamic machine as claimed in claim 1 wherein the machine is a radial flux machine and the pole pieces are axially arranged around the axis.

4. An electrodynamic machine as claimed in claim 1 wherein each pole coil is wound on a bobbin.

5. An electrodynamic machine as claimed in claim 4 wherein the bobbins, coils and pole pieces are unitised as a first structure by embedding in a substrate.

6. An electrodynamic machine as claimed in claim 1 wherein the second structure has an annular band of magnetic structure located adjacent the outer faces of the poles.

7. An electrodynamic machine as claimed in claim 6 wherein the band is inside the first structure and the permanent magnets are outside the first structure.

8. A method of constructing a radial flux electrodynamic machine having a unitary annular stator structure comprising providing a plurality of pole pieces, mounting pole coils to the pole pieces and assembling the pole pieces and coils to form an annular stator with each pole axis radially oriented, embedding the pole pieces and coils in a substrate to thereby unitise the stator, assembling magnetic field creating elements and a pole piece backing element in a rotor with at least one magnetic flux path between the magnetic field creating elements and the pole piece backing element and assembling the stator and rotor.

9. A method of constructing a radial flux electrodynamic machine as claimed in claim 8 comprising winding the pole coils on bobbins and placing the bobbins on pole pieces.

10. A method of constructing an annular flux electrodynamic machine having a unitary annular stator structure comprising providing a plurality of pole pieces, mounting pole coils to the pieces and assembling the pole pieces and coils to form an annular stator with each pole axis axially oriented, embedding the pole pieces and coils in a substrate to thereby unitise the stator, assembling magnetic field creating elements and a pole piece backing element in a rotor with at least one magnetic flux path between the magnetic field creating elements and the pole piece backing element and assembling the stator and rotor.
